SEQUENCE LISTING (2 sequences)

SEQ ID NO: 1 - protein, 54 aa, Pentadiplandra brazzeana
  VARIANT 1: note = X can be glutamine or pyroglutamate
XDKCKKVYENYPVSKCQLANQCNYDCKLDKHARSGECFYDEKRNLQCICDYCEY

SEQ ID NO: 2 - protein, 53 aa, Pentadiplandra brazzeana
DKCKKVYENYPVSKCQLANQCNYDCKLDKHARSGECFYDEKRNLQCICDYCEY

(19) United States
(12) Patent Application Publication
(10) Pub. No.: US 2026/0130388 A1
(43) Pub. Date: May 14, 2026

(54) CHOCOLATE COMPOSITIONS COMPRISING SWEET PROTEIN

(71) Applicant: OOBLI, Inc., Davis, CA (US)

(72) Inventors: Jason Ryder, Oakland, CA (US); Bisma Syeda Parwez, Davis, CA (US); Allison Morgan Wing, Davis, CA (US); Peter Dea, Davis, CA (US); Yamile Mennah Govela, Davis, CA (US)

(21) Appl. No.: 19/121,642

(22) PCT Filed: Oct. 16, 2023
(86) PCT No.: PCT/US2023/076991

§ 371 Date: Apr. 16, 2025

Related U.S. Application Data
(60) Provisional application No. 63/416,809, filed on Oct. 17, 2022.
(60) Provisional application No. 63/530,895, filed on Aug. 4, 2023.

(51) Int. Cl. A23G 1/44; A23G 1/40; A23G 1/48; A23G 1/56

(52) U.S. Cl. CPC A23G 1/44; A23G 1/40; A23G 1/48; A23G 1/56

(57) ABSTRACT

Described herein are chocolate compositions comprising sweet proteins, such as sweet polypeptides (e.g., brazzein, brazzein-52, brazzein-54, or a combination of brazzein-53 and brazzein-54), and method of producing the same.

### CROSS-REFERENCE TO RELATED APPLICATIONS

This application claims priority to U.S. Provisional Patent Application Ser. No. 63/416,809, filed Oct. 17, 2022 and U.S. Provisional Patent Application Ser. No. 63/530,895, filed Aug. 4, 2023; for which the entire contents of each are herein incorporated by reference.

### SEQUENCE LISTING

This application contains a Sequence Listing that has been submitted electronically as an XML file named 54282-0009WO1_SL_ST26.xml. The XML file, created on Sep. 28, 2023, is 3,269 bytes in size. The material in the XML file is hereby incorporated by reference in its entirety.

### TECHNICAL FIELD

This invention relates to chocolate formulations. In particular, this invention relates to chocolate formulations, compositions and products comprising sweet proteins (e.g., recombinant brazzein such as recombinant brazzein-53, recombinant brazzein-54, or a combination of brazzein-53 and brazzein-54).

### BACKGROUND

Sugar consumption has become an increasingly visible health problem throughout the world. High levels of sugar consumption have been linked to obesity and associated health problems including an increased risk of high blood pressure, high cholesterol and Type 2 diabetes, as well as cardiovascular disease. However, sweet food products are favored by a large proportion of the population. There exists a need to provide healthy alternatives that deliver the same desired qualities of sweet foods.

### SUMMARY

There is a need for alternative sweeteners and sweetened formulations that deliver not only overall sweetness, but also the timing and longevity of sweet perception that make sweet foods desirable, and even craveable. Provided herein are sweet proteins and formulations comprising sweet proteins useful for a variety of applications, including, but not limited to, the preparation of sweetened chocolate compositions. The inclusion of such sweet proteins provides a natural sweetener that does not include alternative or artificial sweeteners (such as small molecule sugar alternatives). For example, sweet proteins may have a sweeter taste than naturally occurring saccharides (sugars) and artificial sweeteners, and, as a result, a smaller amount of the sweet protein can be used compared to the naturally occurring saccharides or artificial sweeteners to obtain a similar or comparable sweetness level. The use of sweet proteins (e.g., sweet polypeptides), can also, for example, make the consumption of a product formulated with the sweet polypeptide more enjoyable by, for example, enhancing a sweet taste, or can make the consumption of a product formulated with the sweet polypeptide healthier by, for example, decreasing the amount of sugar in a product and/or by decreasing the total calories. The present disclosure also describes methods of producing the compositions and formulations comprising one or more sweet proteins such as a sweet polypeptide, for example, recombinant brazzein-53, recombinant brazzein-54, or a combination of recombinant brazzein-53 and brazzein-54.

Disclosed herein are chocolate compositions including a recombinant brazzein-54, a recombinant brazzein-53, and a bulking agent. In some cases, the recombinant brazzein-53 is present in the composition between 20 ppm and 40 ppm. In some cases, the recombinant brazzein-53 is present in the composition between 100 ppm and 500 ppm, optionally between 135 ppm and 335 ppm, and the recombinant brazzein-54 is present in the composition between 10 ppm and 100 ppm, optionally between 20 ppm and 50 ppm. In some cases, the composition also includes a low glycemic index sweetener. In some cases, the ratio of recombinant brazzein-53 to low glycemic index sweetener (wt/wt) is between about 1:190 and about 1:1125. In some cases, the ratio of recombinant brazzein-54 to low glycemic index sweetener (wt/wt) is between about 1:900 and about 1:7500. In some cases, the composition also includes cocoa and a fat. In some cases, the also includes comprises an emulsifier. In some cases, the recombinant brazzein-53 is present in the composition between 135 ppm and 255 ppm, and the recombinant brazzein-54 is present in the composition between 20 ppm and 40 ppm. In some cases, the recombinant brazzein-53 is present in the composition between 160 ppm and 305 ppm, and the recombinant brazzein-54 is present in the composition between 20 ppm and 50 ppm.

Also disclosed herein are chocolate compositions including a recombinant brazzein-53, a low glycemic index sweetener, cocoa, a bulking agent, a fat, and, optionally, an emulsifier, where the recombinant brazzein-53 is present in the composition between 100 ppm and 1600 ppm, optionally between 135 ppm and 335 ppm. In some cases, the recombinant brazzein-53 is present in the composition between 150 ppm and 280 ppm. In some cases, the recombinant brazzein-53 is the only brazzein protein in the chocolate composition. In some cases, the ratio of recombinant brazzein-53 to low glycemic index sweetener (wt/wt) is between about 1:130 and about 1:1000. In some cases, the chocolate composition also includes brazzein-54. In some cases, the brazzein-54 is a recombinant brazzein-54. In some cases, the ratio of recombinant brazzein-54 to low glycemic index sweetener (wt/wt) is between about 1:900 and about 1:7500.

Also disclosed herein are chocolate compositions including a recombinant brazzein-54, a low glycemic index sweetener, cocoa, a bulking agent, a fat; and, optionally, an emulsifier, where the recombinant brazzein-54 is present in the composition between 10 ppm and 1600 ppm, optionally between 600 ppm and 1120 ppm or between 720 ppm and 1340 ppm. In some cases, the brazzein-54 is the only brazzein protein in the chocolate composition. In some cases, the ratio of recombinant brazzein-54 to low glycemic index sweetener (wt/wt) is between about 1:33 and about 1:250. In some cases, the ratio of recombinant brazzein-54 to low glycemic index sweetener (wt/wt) is between about 1:33 and about 1:7500. In some cases, the chocolate composition is a dark chocolate. In some cases, the chocolate composition is a milk chocolate. In some cases, the low glycemic index sweetener is a natural sweetener. In some cases, the natural sweetener is agave, or coconut sugar. In some cases, the low glycemic index sweetener is present in an amount between 5-15% wt/wt. In some cases, the bulking agent comprises a low glycemic index bulking agent. In some cases, the low glycemic index bulking agent is tapioca fiber, chicory root fiber, inulin, or soluble corn fiber. In some cases, the inulin is isolated inulin, chicory root inulin, or isolated chicory root inulin. In some cases, the low glycemic index bulking agent is present in an amount between 10-30% wt/wt. In some cases, the composition does not contain a sugar alcohol. In some cases, the fat is present in an amount between 3-25% wt/wt. In some cases, the fat is cocoa butter. In some cases, the chocolate composition also included an emulsifier in an amount between 0.1%-20%% wt/wt. In some cases, the emulsifier is lecithin. In some cases, cocoa is selected from a cocoa powder, a chocolate liquor or a cocoa mass. In some cases, the cocoa is present in an amount between 15% and 80% wt/wt. In some cases, the composition does not comprise cane sugar. In some cases, the ingredients providing sweetness comprises only nature identical ingredients. In some cases, the chocolate composition also included an additional flavoring agent. In some cases, the additional flavoring agent is selected from sea salt, raspberry granules, and vanilla.

Also disclosed herein are solid chocolates including any of the chocolate compositions described herein. Also disclosed herein are liquid chocolates including the chocolate compositions described herein.

Disclosed herein are chocolate including comprising one or more brazzein proteins or recombinant brazzein proteins (e.g., recombinant brazzein-53, recombinant brazzein-54, or a combination of recombinant brazzein-53 and brazzein-54). In some cases, the chocolate is a solid chocolate, a chocolate liquor, a chocolate powder, a milk chocolate, and/or a dark chocolate. In some cases, the sweet protein provides a sweet taste. In some cases, the brazzein protein is a particular form of brazzein such as brazzein-53 or recombinant brazzein-53. In some cases, the sweet protein is a particular form of brazzein such as brazzein-54 or recombinant brazzein-54.

Disclosed herein are chocolate compositions including a recombinant brazzein-53, a low glycemic index sweetener, cocoa, a low glycemic index bulking agent, a fat; and optionally an emulsifier, wherein the recombinant brazzein-53 is present in the composition between 100 ppm and 1600 ppm, optionally between 100 ppm and 1000 ppm or between 135 ppm and 335 ppm.

Also disclosed herein are chocolate compositions including a recombinant brazzein-54; a low glycemic index sweetener; cocoa; a low glycemic index bulking agent; a fat; and optionally an emulsifier, wherein the recombinant brazzein-54 is present in the composition between 10 ppm and 1600 ppm. In some cases, the recombinant brazzein-54 is the sole brazzein protein and is present in an amount between 720 ppm and 1340 ppm. In some cases, the recombinant brazzein-54 is present with other sweet proteins, such as brazzein-53, and the recombinant brazzein-54 is present in an amount between 20 ppm and 50 ppm.

Also disclosed herein are chocolate compositions including a recombinant brazzein-53 and a recombinant brazzein-54; a low glycemic index sweetener; cocoa; a low glycemic index bulking agent; a fat; and optionally an emulsifier, wherein the recombinant brazzein-53 is present in the composition between 100 ppm and 500 ppm, optionally between 135 ppm and 305 ppm, and the recombinant brazzein-54 is present in the composition between 10 ppm and 100 ppm, optionally between 20 ppm and 50 ppm.

Also disclosed herein are solid chocolates including any of the chocolate compositions disclosed herein. Also disclosed herein are liquid chocolates including the chocolate compositions disclosed herein.

In some cases, the total recombinant brazzein (e.g., brazzein-53, brazzein-54, or a combination thereof) is present in the composition between 100 and 1600 ppm. In some cases, the total recombinant brazzein is present in the composition between 100 and 350 ppm. In some cases, the total recombinant brazzein comprises recombinant brazzein-53. In some cases, the total recombinant brazzein comprises recombinant brazzein-54. In some cases, the total recombinant brazzein comprises recombinant brazzein-53 and recombinant brazzein-54.

In some cases, the low glycemic index sweetener is a natural sweetener. In some cases, the natural sweetener is agave or coconut sugar. In some cases, the low glycemic index sweetener is present in an amount between 5-15% wt/wt. In some cases, the ratio of recombinant brazzein (e.g., brazzein-53, brazzein-54, or brazzein-53 and brazzein-54) to low glycemic index sweetener (weight to weight, wt/wt) is between about 1:130 and about 1:1125. In some cases, the ratio of recombinant brazzein to low glycemic index sweetener (wt/wt) is between about 1:280 and about 1:745.

In some cases, the bulking agent comprises a low glycemic index bulking agent. In some cases, the low glycemic index bulking agent is tapioca fiber, chicory root fiber, inulin, and/or soluble corn fiber. In some cases, the inulin is isolated inulin, chicory root inulin, or isolated chicory root inulin. In some cases, the low glycemic index bulking agent is chicory root inulin. In some cases, the low glycemic index bulking agent is present in an amount between 10-30% wt/wt.

In some cases, the composition does not contain a sugar alcohol. In some cases, the composition does not comprise cane sugar.

In some cases, the fat is present in an amount between 3-25% wt/wt. In some cases, the fat is cocoa butter.

In some cases, the composition includes an emulsifier. In some cases, the composition does not include an emulsifier. If the emulsifier is present, the emulsifier is present in an amount between 0.1% and about 25% wt/wt (e.g., about 0.25%, about 0.3%, about 6%, about 20%). In some cases, if the emulsifier is present, the emulsifier is lecithin.

In some cases, cocoa is selected from a cocoa powder, a chocolate liquor or a cocoa mass. In some cases, the sweetener comprises only nature identical ingredients.

Any of the chocolate composition described herein can further include an additional flavoring agent. In some cases, the additional flavoring agent is selected from sea salt, raspberry granules, and vanilla.

The details of one or more cases of the invention are set forth in the accompanying drawings and the description below. Other features, objects, and advantages of the invention will be apparent from the description and drawings, and from the claims. Unless otherwise defined, all technical and scientific terms used herein have the same meaning as commonly understood by one of ordinary skill in the art to which this invention belongs. Methods and materials are described herein for use in the present invention; other, suitable methods and materials known in the art can also be used. The materials, methods, and examples are illustrative only and not intended to be limiting. All publications, patent applications, patents, sequences, database entries, and other references mentioned herein are incorporated by reference in their entirety. In case of conflict, the present specification, including definitions, will control.

### DESCRIPTION OF DRAWINGS

FIG. 1 is an exemplary SDS-PAGE showing protein production during fermentation monitored for the presence of the 6.5 kilo Daltons (kDa) brazzein-53 recombinant protein (arrow) as compared to known standards. EFT (elapsed fermentation time).

### DETAILED DESCRIPTION

Described herein are chocolate compositions, formulations and products comprising one or more sweet proteins, such as brazzein-53, brazzein-54, or a combination of brazzein-53 and brazzein-54. In some cases, the chocolate is a solid chocolate, a chocolate liquor, a powdered chocolate, a milk chocolate, and/or a dark chocolate. In some cases, the sweet protein provides a sweet taste. In some cases, the sweet protein is a recombinant brazzein, such as a recombinant brazzein-53, recombinant brazzein-54, or both recombinant brazzein-53 and recombinant brazzein-54, produced by fermentation.

### Taste and Taste Receptors

Taste is a form of chemoreception which occurs in taste receptors in the mouth and is one of a variety of mechanisms used by mammals to sense stimuli and the external environment. Humans and other mammals have taste receptors on taste buds of the tongue and other areas, including the epiglottis. Each taste bud can have a pore that opens out to the surface of the tongue, enabling molecules and ions taken into the mouth to reach the receptor cells inside.

The taste sensations, which include salt, sour, sweet, bitter, and umami, can be sensed by one or more mechanism(s) and by one or more taste receptor(s). Taste receptors involved in the sensation of taste include Type 1 taste receptors (TAS1, e.g., TAS1R2 and TAS1R3) and Type 2 taste receptors (TAS2, e.g., TAS2R1-TAS2R50). Type 1 taste receptors are generally associated with sweetness and Type 2 taste receptors are generally associated with bitterness.

A taste can change over the process of eating a composition. A tasting profile can be described as having a starting taste/flavor and a finishing taste/flavor. A starting taste and finishing taste can have a temporal element, i.e., how fast the starting taste is detected by a subject or how long the finishing flavor is detectable by a subject. A finishing taste/flavor can be described as lingering, meaning the finishing taste/flavor is discernable by a subject for a long time (e.g., 5 second, 10 seconds, 30 seconds, or 1 minute) after swallowing the composition responsible for causing the taste.

### Sweet Proteins

Sweet proteins (also referred to herein as sweet polypeptides) may be formulated into a variety of products and may be consumed in order to achieve a desired level and timing of sweetness. In some cases, the sweet polypeptide may yield a sweet taste when consumed by a subject (e.g., a human). The present disclosure describes compositions and formulation comprising sweet polypeptides that, for example, can impart, elicit, and/or enhance a sweet taste.

In some cases, the present disclosure describes sweet polypeptides, such as those that may generate a sweet taste and/or enhance sweetness when tasted or consumed by humans. In some cases, sweet polypeptides may be sweet-tasting and may taste sweet, for example, to a human subject. The disclosed polypeptides can generate a sweet taste and/or enhance a sweet taste of a composition, for example, as an ingredient or component of a chocolate formulation or chocolate product.

The terms “polypeptide,” “peptide,” and “protein” are used interchangeably herein to refer to polymers of amino acids of any length. The polymer may be linear or branched, it may comprise modified amino acids (e.g., pyroglutamate (pGlu)), and/or it may be interrupted by non-amino acids. The terms also encompass an amino acid polymer that has been modified, for example, disulfide bond formation, glycosylation, lipidation, acetylation, phosphorylation, or any other manipulation, such as conjugation with a labeling component. As used herein, the term “amino acid” refers to either natural and/or unnatural or synthetic amino acids, including pyroglutamate (pGlu) and both the D or L optical isomers, amino acid analogs, and/or peptidomimetics.

### Brazzein and Recombinant Brazzein

Sweet polypeptides provided herein may have a sweeter taste than naturally occurring saccharides and artificial sweeteners. A non-limiting example of a sweet polypeptide having a sweet taste includes any of the forms of the protein brazzein, including brazzein-53 and brazzein-54. In some cases, the sweetness of the protein, as determined by a human subject, for example in a side-by-side gustatory comparison, can be greater than that of saccharides sweeteners and artificial sweeteners.

Brazzein is a small, sweet-tasting protein originally isolated from the fruit of West African plant, Pentadiplandra brazzeana Baillon. (See, for example, Ming D et al., FEES Lett. (1994) 20 355:106-108, incorporated by reference in its entirety). It is a monomer protein with a molecular weight of 6.5 Kd. As a member of the Csβα fold family, it contains four disulfide bonds that lend a high degree of thermal and pH stability to its structure. Specifically, the sweet taste of brazzein remains after incubation at 98° C. for 2 h and at 80° C. for 4.5 h in the pH range of 2.5-8. It is also water soluble (>50 mg/mL). It is a highly soluble protein (more than 50 g/L) with an isoelectric point of 5.4. Residues 29-33, 36, and 39-43, as well as the C-terminus of the protein, may be involved in the sweet taste of the protein. The charge of the protein may also play an important role in its interaction with the sweet taste receptor.

At least three forms of the protein are known, although only two forms are present in ripe fruit. The major form is 54 amino acids long (pGlu-brazzein, referred to as “brazzein-54” herein), is about 80% of the total major and minor brazzein protein content, and contains a pyroglutamate (pGlu) residue at its N-terminus (SEQ ID NO: 1; UniProt database under Accession No. P56552; Table 1). The minor form is 53 amino acids long (des-pGlu-brazzein), referred to as “brazzein-53” herein), makes up about 20% of the total brazzein protein (major form and minor form combined), content lacks the final pyroglutamate residue (SEQ ID NO: 2; Table 1).

TABLE 1
Exemplary Brazzein Amino Acid Sequences.

| SEQ | Peptide | |
|---|---|---|
| ID NO: | Description | Sequence |
| 1 | Brazzein-54 | XDKCKKVYENYPVSKCQLANQCNYDCKLD |
| | | KHARSGECFYDEKRNLQCICDYCEY |
| 2 | Brazzein-53 | DKCKK VYENYPVSKCQLANQCNYDCKLD |
| | | KHARSGECFYDEKRNLQCICDYCEY |

X can be glutamine or pyroglutamate.

On a weight basis, brazzein may taste 500 to 2000 times sweeter than sucrose, as compared to a 10% sucrose and a 2% sucrose solution, respectively. Sucrose, a commonly used sweetener, is a disaccharide molecule composed of glucose and fructose.

As described below, the brazzein can be the major form of brazzein (i.e., brazzein-54) or the minor form of brazzein (i.e., brazzein-53). In addition, brazzein can be naturally produced by the fruit or produced recombinantly by, for example, by fungi (e.g., yeast) or bacterial cell genetically engineered to produce recombinant brazzein (e.g., recombinant brazzein-53 or recombinant brazzein-54).

### Chocolate Compositions Comprising Sweet Polypeptides

Disclosed herein are compositions and formulations for chocolates comprising one or more sweet polypeptides such as recombinant brazzein (e.g., recombinant brazzein-53, recombinant brazzein-54, or a combination of recombinant brazzein-53 and recombinant brazzein-54).

Non-limiting exemplary types of chocolate compositions include dark chocolate, milk chocolate, bakers' chocolate, white chocolate, solid chocolate, liquid chocolate (e.g., chocolate liquor), and chocolate syrup that contain brazzein, particularly recombinant brazzein (e.g., recombinant brazzein-53, recombinant brazzein-54, or a combination of recombinant brazzein-53 and recombinant brazzein-54).

In some cases, a chocolate composition comprises one or more recombinant brazzein proteins (e.g., recombinant brazzein-53, recombinant brazzein-54, or a combination of recombinant brazzein-53 and recombinant brazzein-54), and additional ingredients, such as one or more of a low glycemic index bulking agent, a sweetener (e.g., a low glycemic index sweetener or natural sweetener(s)), cocoa, and a fat. In some cases, the chocolate composition does not comprise sugar, such as cane sugar. In some cases, the chocolate composition does not comprise any other sweetener. For example, the sweetener is only recombinant brazzein (e.g., recombinant brazzein-53 or recombinant brazzein-54), or the sweeteners are recombinant brazzein (e.g., recombinant brazzein-53 or recombinant brazzein-54) and a low glycemic index sweetener.

### Amount of Recombinant Brazzein

The amount of recombinant brazzein (e.g., recombinant brazzein-53, recombinant brazzein-54, or a combination of recombinant brazzein-53 and recombinant brazzein-54) present in any of the compositions disclosed herein is any amount that confers one or more improved organoleptic properties of the consumable (e.g., chocolate) to which the brazzein is added (e.g., taste, sight, smell, and texture (e.g., mouthfeel)) compared to a comparable composition lacking brazzein. In a particular case, the improved organoleptic property is associated with taste. In one case, improving one or more organoleptic property results in the improvement of the taste profile. The overall taste profile of a composition is an interplay of several different tastes and senses, such as sweetness, sourness, bitterness, and the like. Examples of improved organoleptic properties can include, for example, a reduction in bitterness, a reduction in astringent and licorice notes, faster onset of sweetness, slower onset of sweetness, a reduction in lingering sweetness, a reduction in lingering bitterness, a reduction in bitter aftertaste, a reduction in metallic aftertaste, a reduction in chemical and synthetic aftertaste, and a combination thereof. In a particular case, the term “improved organoleptic properties” means that the composition (e.g., a chocolate) will have one or more improved organoleptic properties for the majority of users, i.e., between about 50% to about 100% of a population of humans (e.g., between about 60% to about 100%, between about 70% to about 100%, between about 80% to about 100%, or between about 90% to about 100% of a population of humans). The improvement may be expressed qualitatively, e.g., as a gustatory comparison or a comparison taste test, or quantitatively, e.g., as a percentage improvement or as a value on a comparative scale (see, for example, Example 2). For example, a human or a population of humans can compare any of the chocolate compositions described herein to a similar commercially available product, to any of the other chocolate compositions described herein, or to a similar chocolate composition made with cane sugar. Any of the chocolate compositions described herein can have any of the improved organoleptic properties, as determined by any of the methods described herein. For example, any of the chocolate compositions described herein can have an increase of sweetness, a reduction of sweetness, a reduction in bitterness, a faster onset of sweetness, or a reduction in lingering sweetness.

Brazzein (e.g., brazzein-53, recombinant brazzein-53, brazzein-54, recombinant brazzein-54, or any combination thereof) is present in the chocolate compositions described herein in ppm. As used herein “ppm” refers to parts per million of brazzein protein in the chocolate composition. In some cases, the chocolate compositions herein are described by total weight, such as 100 g total weight compositions, and the brazzein in such compositions is provided in ppm. The units of ppm can be converted to a percentage of brazzein protein in the total weight of the chocolate composition. For example, 0.01% wt brazzein/wt total of the chocolate composition=100 ppm brazzein and 0.01% wt brazzein/wt total of the chocolate composition=0.01 g brazzein/100 g of the chocolate composition. In some cases, the recombinant brazzein-53 is present in the chocolate composition between about 100 ppm and about 1600 ppm or any range included therein (e.g., about 100 ppm and about 600 ppm, about 100 ppm and about 500 ppm, about 250 ppm and about 350 ppm, or about 135 ppm and about 335 ppm). For example, the recombinant brazzein can be present in the composition between about 100 ppm and about 1400 ppm, between about 100 ppm and about 1200 ppm, between about 100 ppm and about 1000 ppm, between about 100 ppm and about 800 ppm, between about 100 ppm and about 600 ppm, between about 200 ppm and about 1400 ppm, between about 200 ppm and about 1200 ppm, between about 200 ppm and about 1000 ppm, between about 200 ppm and about 800 ppm, between about 200 ppm and about 600 ppm, between about 250 ppm and about 1400 ppm, between about 250 ppm and about 1200 ppm, between about 250 ppm and about 1000 ppm, between about 250 ppm and about 800 ppm, between about 250 ppm and about 600 ppm, between about 350 ppm and about 1400 ppm, between about 350 ppm and about 1200 ppm, between about 350 ppm and about 1000 ppm, between about 350 ppm and about 800 ppm, between about 350 ppm and about 600 ppm, between about 135 ppm and about 335 ppm, between about 135 ppm and about 255 ppm, between about 180 ppm and about 335 ppm, between about 150 ppm and about 280 ppm or between about 165 ppm and about 305 ppm. In some cases, the recombinant brazzein is present in the composition between about 100 ppm and about 500 ppm. In some cases, the recombinant brazzein is present in the composition between about 250 ppm and about 350 ppm. In some cases, the recombinant brazzein is present in the composition between about 100 ppm and about 300 ppm. In some cases, the recombinant brazzein is present in the composition between about 135 ppm and about 335 ppm. In some cases, the recombinant brazzein is present in the composition between about 135 ppm and about 255 ppm. In some cases, the recombinant brazzein is present in the composition between about 135 ppm and about 280 ppm. In some cases, the recombinant brazzein is present in the composition between about 165 ppm and about 305 ppm. In some cases, the recombinant brazzein is present in the composition between about 165 ppm and about 335 ppm. In some cases, the recombinant brazzein is present in the composition between about 150 ppm and about 280 ppm. In some cases, the recombinant brazzein is present in the composition between about 180 ppm and about 335 ppm.

Any of the compositions described herein can include brazzein-53 and brazzein-54. The brazzein-54 to brazzein-53 ratio (wt/wt) in any of the compositions described herein can be from about 1:2 to about 1:20. For example, the brazzein-54 to brazzein-53 ratio in any of the compositions described herein can be from about 1:2 to about 1:13, from about 1:3 to about 1:13, from about 1:3.375 to about 1:12.75, from about 1:3.3 to about 12.2, about 1:2, about 1:3, about 3.3, about 1:3.375, about 1:4, about 1:5, about 1:6, about 1:6.6, about 1:7, about 1:8 about 1:9, about 1:10, about 1:11, about 1:12, about 12.2, about 12.75, about 1:13, about 1:13.4, about 1:14, about 1:15, about 1:16, about 1:17, about 1:18, about 1:19, about 1:20.

In some cases, a composition includes chocolate, brazzein-53, and brazzein-54. In some cases, the composition including chocolate, brazzein-53, and brazzein-54 has a ratio (wt/wt) of brazzein-54 to brazzein-53 is from about 1:3.375 to about 1:12.75. In some cases, the composition including chocolate, brazzein-53, and brazzein-54 has a ratio of brazzein-54 to brazzein-53 is from about 1:3.375 to about 1:6.375. In some cases, the composition including chocolate, brazzein-53, and brazzein-54 has a ratio of brazzein-54 to brazzein-53 is from about 1:6.75 to about 12.75. In some cases, the composition including chocolate, brazzein-53, and brazzein-54 has a ratio of brazzein-54 to brazzein-53 is from about 1:3.3 to about 1:12.2. In some cases, the composition including chocolate, brazzein-53, and brazzein-54 has a ratio of brazzein-54 to brazzein-53 is from about 1:3.3 to about 1:6.1. In some cases, the composition including chocolate, brazzein-54, and brazzein-53 has a ratio of brazzein-53 to brazzein-54 is from about 1:6.6 to about 1:12.2.

### Sweeteners (e.g., Low Glycemic Index Sweeteners)

Any appropriate sweetener can be added to the chocolate composition at any amount to achieve an appropriate taste profile. Non-limiting examples of sweeteners include low glycemic index sweeteners and small molecule sweeteners.

Low glycemic index sweeteners—A sweetener can be a low glycemic index sweetener. For example, a low glycemic index sweetener can be added to the chocolate composition. A low glycemic index sweetener can, for example, improve organoleptic properties, such as a faster onset of sweetness compared to a composition without the low glycemic index sweetener. The glycemic index is a value assigned to foods based on how slowly or how quickly those foods cause increases in blood glucose level. Low glycemic index foods can achieve a more beneficial effect on blood glucose control, for example, in people with diabetes mellitus, and may also provide metabolic benefits for the general population. Methods for testing the glycemic index of a beverage have been described, e.g., as provided in Wolever, et al. Nutrition Research 23:621-629, 2003. Low glycemic index foods, including low glycemic index sweeteners have a glycemic index of 55 or less.

Low glycemic index sweeteners can be a natural sweetener or a non-natural sweetener. In some cases, the low glycemic index sweetener is a natural sweetener. In some cases, the low glycemic index sweetener is not a natural sweetener. In some cases, the low glycemic index sweetener comprises only nature identical ingredients (i.e., ingredients that can be found in nature in the exact same form or that are substantially the same). Non-limiting exemplary natural low glycemic index sweeteners include stevia, xylitol, lankanto (fermented erythritol), coconut sugar (also known as coconut palm sugar), agave (e.g., agave syrup), yacon, maple syrup, molasses, lucuma fruit, and monk fruit.

The low glycemic index sweetener(s) can be present in any of the compositions described herein. In some cases, the low glycemic index sweetener is present in an amount between about 5% and about 15% wt/wt or any range included therein (e.g., between about 5% and about 10% wt/wt, between about 7% to about 13%, or between about 10% to about 15%). For example, the low glycemic index sweetener can be present in an amount between about 5% and about 13%, between about 5% and about 11%, between about 5% and about 9%, between about 5% and about 7%, between about 7% and about 15%, between about 9% and about 15%, between about 11% and about 15%, between about 13% and about 15%, between about 7% and about 13%, or between about 9% and about 11%. In some cases, the low glycemic index sweetener is present in an amount between about 1% and about 5% wt/wt or any range included therein (e.g., between about 1% and about 2% wt/wt, between about 2% and about 3% wt/wt, between about 3% and about 4% wt/wt, between about 4% and about 5% wt/wt, between about 1% and about 4% wt/wt, between about 1% and about 3% wt/wt, between about 1% and about 2% wt/wt, between about 2% and about 3% wt/wt, between about 2% and about 4% wt/wt, between about 2% and about 5% wt/wt, between about 3% and about 4% wt/wt, or between about 3% and about 5% wt/wt).

Alternatively, the amount of low glycemic index sweetener can be measured as a ratio of brazzein (e.g., brazzein-53, brazzein-54, or a combination of brazzein-53 and brazzein-54) to low glycemic index sweetener (weight to weight, wt/wt). In some cases, the ratio of brazzein-53 to low glycemic index sweetener is between about 1:100 and about 1:1125 or any range included therein (e.g., about 1:130 to about 1:1125, about 1:130 to about 1:375, about 1:430 to about 1:1125, about 1:390 to about 1:745, about 1:310 to about 1:580, or about 1:280 to about 1:745). In some cases, the ratio of brazzein-53 to low glycemic index sweetener is between about 1:29 and about 1:778 or any range included therein. In some cases, the ratio of brazzein-53 to low glycemic index sweetener is between about 1:41 and about 1:200. In some cases, the ratio of brazzein-53 to low glycemic index sweetener is about 1:195. In some cases, the ratio of brazzein-54 to low glycemic index sweetener is between about 1:30 and about 1:7500 or any range included therein (e.g., about 1:30 to about 1:2500, about 1:100 to about 1:7500, about 1:70 to about 1:5000, about 1:2500 to about 1:5000, or about 1:1900 to about 1:3800). In some cases, the ratio of brazzein-54 to low glycemic index sweetener is between about 1:7 and about 1:5250 or any range included therein. In some cases, the ratio of brazzein-54 to low glycemic index sweetener is between about 1:299 and about 1:892. In some cases, the ratio of brazzein-54 to low glycemic index sweetener is about 1:892. In some cases, the ratio of brazzein-53 to agave is between about 1:100 and about 1:1125 or any range included therein (e.g., about 1:130 to about 1:1125, about 1:130 to about 1:375, about 1:430 to about 1:1125, about 1:390 to about 1:745, about 1:310 to about 1:580, or about 1:280 to about 1:745). In some cases, the ratio of brazzein-54 to agave is between about 1:30 and about 1:7500 or any range included therein (e.g., about 1:30 to about 1:2500, about 1:100 to about 1:7500, about 1:70 to about 1:5000, about 1:2500 to about 1:5000, or about 1:1900 to about 1:3800). In some cases, the ratio of brazzein-53 to coconut sugar is between about 1:100 and about 1:1125 or any range included therein (e.g., about 1:130 to about 1:1125, about 1:130 to about 1:375, about 1:430 to about 1:1125, about 1:390 to about 1:745, about 1:310 to about 1:580, or about 1:280 to about 1:745). In some cases, the ratio of brazzein-53 to coconut sugar is between about 1:29 and about 1:778 or any range included therein. In some cases, the ratio of brazzein-53 to coconut sugar is between about 1:41 and about 1:200. In some cases, the ratio of brazzein-53 to coconut sugar is about 1:195. In some cases, the coconut sugar comprises about 84% sugar content (wt/wt). In some cases, the ratio of brazzein-54 to coconut sugar is between about 1:30 and about 1:7500 or any range included therein (e.g., about 1:30 to about 1:2500, about 1:100 to about 1:7500, about 1:70 to about 1:5000, about 1:2500 to about 1:5000, or about 1:1900 to about 1:3800). In some cases, the ratio of brazzein-54 to coconut sugar is between about 1:7 and about 1:5250 or any range included therein. In some cases, the ratio of brazzein-54 to coconut sugar is between about 1:299 and about 1:892. In some cases, the ratio of brazzein-54 to coconut sugar is about 1:892. In some cases, the coconut sugar comprises about 84% sugar content (wt/wt).

In some cases, any of the compositions described herein do not include sugar, such as cane sugar. In some cases, any of the compositions described herein do not include any other natural sweetener.

Sugar Alcohol and Other Small Molecule Sweeteners—Sugar alcohols (also called polyhydric alcohols, polyalcohols, alditols or glycitols) are organic compounds, often derived from sugars, containing one hydroxyl group (—OH) attached to each carbon atom. Non-limiting exemplary sugar alcohols include sorbitol, mannitol, erythritol, and stevia. In some cases, the chocolate composition contains a sugar alcohol. In some cases, the chocolate composition does not contain a sugar alcohol. In some cases, a sugar alcohol is present in an amount between about 0.001% wt/wt and about 20% wt/wt (e.g., between about 1% wt/wt and about 20% wt/wt, between about 5% wt/wt and about 20% wt/wt, between about 10% wt/wt and about 20% wt/wt, between about 15% wt/wt and about 20% wt/wt, or between about 14% wt/wt and about 18% wt/wt) In some cases, a sugar alcohol is present in an amount equal to about 16% wt/wt.

In some cases, the chocolate compositions herein containing brazzein or recombinant brazzein (e.g., recombinant brazzein-53, recombinant brazzein-54, or a combination of recombinant brazzein-53 and recombinant brazzein-54) do not include any small molecule sugar substitutes, such as stevia or other sugar alcohols. In some cases, the chocolate compositions herein contain sucrose or a combination of sucrose and fructose, in addition to brazzein or recombinant brazzein (e.g., recombinant brazzein-53, recombinant brazzein-54, or a combination of recombinant brazzein-53 and recombinant brazzein-54), but do not contain any additional sweeteners.

### Cocoa

Cocoa can be included in any of the chocolate compositions described herein. Non-limiting examples of cocoa include cocoa powder, chocolate liquor, and cocoa mass.

Cocoa can have a bitter taste or bitter after taste in chocolate compositions. The brazzein present in an amount that reduces the bitterness of the chocolate composition. In some cases, the reduction in bitterness is experienced by a majority of subjects, i.e., between about 50% to about 100% of a population of humans (e.g., between about 60% to about 100%, between about 70% to about 100%, between about 80% to about 100%, or between about 90% to about 100% of a population of humans). The comparison is made to a consumable to which the sweet protein has not been added. For example, the bitterness of the chocolate composition can be reduced by 1.2 fold, 1.25 fold, 1.5 fold, 1.75 fold, 2 fold, 3 fold, 5 fold, 10 fold, 15 fold or 25 fold compared to the same chocolate composition made without the brazzein. In some cases, the bitterness of the chocolate composition can be reduced by 5%, 10%, 20%, 25%, 30%, 40%, 50%, 60%, 70%, 75%, 80% or 90%.

The cocoa can be present in an amount between about 15% wt/wt and about 90% wt/wt, or any range included therein (e.g., between about 15% wt/wt and about 35% wt/wt, or between about 60% wt/wt and about 90%). In some cases, the cocoa is present in an amount wt/wt, between about 15% wt/wt and about 33% wt/wt, between about 15% wt/wt and about 31% wt/wt, between about 15% wt/wt and about 30% wt/wt, between about 15% wt/wt and about 25% wt/wt, between about 17% wt/wt and about 22% wt/wt, between about 27% wt/wt and about 40% wt/wt, between about 29% wt/wt and about 40% wt/wt, between about 30% wt/wt and about 40% wt/wt, between about 33% wt/wt and about 40% wt/wt, between about 35% wt/wt and about 40% wt/wt, or between about 33% wt/wt and about 37% wt/wt. In some cases, the cocoa is present in an amount equal to about 20% wt/wt. In some cases, the cocoa is present in an amount between about 60% wt/wt and about 77% wt/wt, between about 60% wt/wt and about 75% wt/wt, between about 60% wt/wt and about 73% wt/wt, between about 60% wt/wt and about 70% wt/wt, between about 63% wt/wt and about 80% wt/wt, between about 65% wt/wt and about 80% wt/wt, between about 67% wt/wt and about 80% wt/wt, between about 70% wt/wt and about 80% wt/wt, or between about 67% wt/wt and about 73% wt/wt. In some cases, the cocoa is present in an amount equal to about 70% wt/wt.

In some cases, the cocoa powder is present in an amount between about 15% wt/wt and about 35% wt/wt. In some cases, the cocoa powder is present in an amount equal to about 20% wt/wt. In some cases, the cocoa powder is present in an amount between about 60% wt/wt and about 80% wt/wt. In some cases, the cocoa powder is present in an amount equal to about 70% wt/wt.

In some cases, the chocolate liquor is present in an amount between about 15% wt/wt and about 35% wt/wt. In some cases, the chocolate liquor is present in an amount equal to about 20% wt/wt. In some cases, the chocolate liquor is present in an amount between about 60% wt/wt and about 80% wt/wt. In some cases, the chocolate liquor is present in an amount equal to about 70% wt/wt.

In some cases, the cocoa mass is present in an amount between about 15% wt/wt and about 35% wt/wt. In some cases, the cocoa mass is present in an amount equal to about 20% wt/wt. In some cases, the cocoa mass is present in an amount between about 60% wt/wt and about 80% wt/wt. In some cases, the cocoa mass is present in an amount equal to about 70% wt/wt.

In some cases, the cocoa (e.g., cocoa powder, chocolate liquor, or cocoa mass) is present in any amount that reduces the bitter aftertaste of the chocolate composition compared to the chocolate composition made without the brazzein. In one case, the reduction in bitter aftertaste is experienced by a majority of subjects, i.e., between about 50% to about 100% of a population of humans (e.g., between about 60% to about 100%, between about 70% to about 100%, between about 80% to about 100%, or between about 90% to about 100% of a population of humans). The comparison is made to a consumable to which the sweet protein has not been added.

### Bulking Agents

When using a sweet protein in a chocolate composition, less sucrose or cane sugar may be used, or even no sucrose or cane sugar, and the sweetness can instead be replaced in part or all with a sweet polypeptide, such as brazzein. However, the mass of the sucrose or cane sugar is often replaced with a bulking agent. In some cases, replacing the sucrose or cane sugar allows for the texture to remain similar to what an original formulation or product in terms of organoleptic properties. The bulking agent for use with the chocolate compositions herein include a low glycemic index bulking agent. A low glycemic index bulking agent can be added to the chocolate composition for example, to improve the mouthfeel of the composition as compared to a composition without the bulking agent or as compared to a composition with cane sugar (such as compared with a chocolate composition with cane sugar and without any brazzein). In some cases, the low glycemic index bulking agent is a soluble fiber, i.e., fiber that can dissolve in water. Soluble fiber is composed of carbohydrates. Non-limiting examples of foods that contain soluble fiber include fruits, oats, barley, and legumes such as peas and corn. Non-limiting examples of soluble fibers include psyllium, pectin, wheat dextrin, oligosaccharides, corn fiber, chicory root fiber, isolated inulin, and beta-glucan (e.g., from oat products). Non-limiting exemplary low glycemic index bulking agents for use with the chocolate compositions herein include tapioca fiber, chicory root fiber, isolated inulin (e.g., chicory root inulin), and soluble corn fiber.

In some cases, the low glycemic index bulking agent is present in an amount between about 10% wt/wt and about 30% wt/wt or any range included therein (e.g., about 15% to about 30%, about 10% and about 20%, about 10% and about 15%, about 15% and about 25%, about 20% and about 25%, or about 15% and about 20%). In some cases, the low glycemic index bulking agent is present in an amount between about 10% wt/wt and about 25% wt/wt or any range included therein (e.g., about 10% and about 20%, about 10% and about 15%, about 15% and about 25%, about 20% and about 25%, or about 15% and about 20%). In some cases, the low glycemic index bulking agent is present in an amount between about 10% wt/wt and about 24% wt/wt, between about 10% wt/wt and about 22% wt/wt, between about 10% wt/wt and about 20% wt/wt, between about 10% wt/wt and about 18% wt/wt, between about 10% wt/wt and about 16% wt/wt, between about 10% wt/wt and about 14% wt/w, between about 10% wt/wt and about 12% wt/wt, between about 12% wt/wt and about 25% wt/wt, between about 14% wt/wt and about 25% wt/wt, between about 16% wt/wt and about 25% wt/wt, between about 18% wt/wt and about 25% wt/wt, between about 20% wt/wt and about 25% wt/wt, or between about 22% wt/wt and about 25% wt/wt. In some cases, chicory root fiber is present in an amount between about 10% wt/wt and about 30% wt/wt. In some cases, isolated inulin is present in an amount between about 10% wt/wt and about 30% wt/wt. In some cases, chicory root inulin is present in an amount between about 10% wt/wt and about 30% wt/wt. In some cases, soluble corn fiber is present in an amount between about 10% wt/wt and about 30% wt/wt. In some cases, chicory root inulin is present in an amount of about 15% wt/wt to about 20% wt/wt (e.g., about 17.4% wt/wt). In some cases, tapioca fiber is present in an amount of about 7% wt/wt to about 12% wt/wt (e.g., about 9.25% wt/wt).

In some cases, the chocolate composition can include two or more low glycemic index bulking agents. In some cases, two or more low glycemic index bulking agents are chicory root inulin and tapioca fiber. In some cases, chicory root inulin is present in an amount of about 15% wt/wt to about 20% wt/wt (e.g., about 17.4% wt/wt) and tapioca fiber is present in an amount of about 7% wt/wt to about 12% wt/wt (e.g., about 9.25% wt/wt).

### Fats

Any of the chocolate compositions described herein may include a fat. Fats can improve the consistency of a chocolate composition in terms of, for example, taste, mouth feel, or handling/manufacturing purposes. Non-limiting exemplary fat types include cocoa butter, cacao butter, butter, coconut oil, and butter substitutes. In some cases, the fat is cocoa butter.

The fat may be present in any of the chocolate composition described herein in an amount between about 1% to about 55% (e.g., between about 1% and about 50%, between about 5% and 15%, between about 10% and about 40%, or between about 3% and about 5% wt/wt. In some cases, cocoa butter is present in an amount between about 3% to about 5% wt/wt.

### Emulsifiers

Optionally, an emulsifier may be included in any of the chocolate compositions described herein. Emulsifiers can improve the consistency of a chocolate composition in terms of, for example, taste, mouth feel, or handling/manufacturing purposes. Non-limiting exemplary emulsifiers can include polysorbates (e.g., polyoxyethylene sorbitan monooleate (polysorbate 80), polysorbate 20, polysorbate 60), sodium dodecylbenzenesulfonate, dioctyl sulfosuccinate or dioctyl sulfosuccinate sodium, sodium dodecyl sulfate, cetylpyridinium chloride (hexadecylpyridinium chloride), hexadecyltrimethylammonium bromide, sodium cholate, carbamoyl, choline chloride, sodium glycocholate, sodium taurodeoxycholate, lauric arginate, sodium stearoyl lactylate, sodium taurocholate, lecithins, sucrose oleate esters, sucrose stearate esters, sucrose palmitate esters, sucrose laurate esters, and milk powder (e.g., whole milk powder or skim milk powder). In some cases, if the emulsifier is present, the emulsifier is lecithin.

If present, emulsifiers may be present in an amount between about 0.1% wt/wt and about 25% wt/wt (e.g., about 4% and about 7%, about 5% and about 8%, about 6% and about 9%, about 7% and about 10%, or about 18% wt/wt to about 22% wt/wt). In some cases, lecithin is present in an amount between about 4% wt/wt and about 10% wt/wt. In some cases, milk powder (e.g., whole milk powder) is present an amount of about 20% wt/wt.

### Additional Flavoring Agents

The chocolate compositions herein may include additional flavoring agents. Additional flavoring agents can impart additional flavors or tastes. Non-limiting exemplary additional flavoring agents include spices (e.g., vanilla, cinnamon), fruit flavors (e.g., fruit granules), savory flavors (e.g., sea salt, cayenne, pretzels or pretzel pieces, herbs such as mint), nuts or nut butters (e.g., hazelnut, almond, peanut), grains (e.g., puffed rice or crisped rice), and milk powder (e.g., whole milk powder or skim milk powder). Non-limiting exemplary fruit granules can include raspberry granules, orange granules, and cherry granules. In some cases, the chocolate composition further comprises an additional flavoring agent. In some cases, the additional flavoring agent is sea salt. In some cases, the additional flavoring agent is raspberry granules. In some cases, the additional flavoring agent can be an oil (e.g., mint oil, orange oil, etc.). In some cases, the additional flavoring agent can be vanilla (e.g., vanilla extract, vanilla bean, vanilla bean paste, natural vanilla flavoring, vanilla syrup, vanilla bean powder, vanilla salt, and vanilla sugar).

Any of the flavoring agents described herein can be present in an amount between about 0.1% wt/wt and about 25% wt/wt (e.g., between about 0.4% wt/wt and about 0.6% wt/wt, between about 0.2% wt/wt and about 0.7% wt/wt, or between about 3% wt/wt about 4% wt/wt, and about 20% wt/wt). In some cases, the flavoring agent is present in an amount between about 0.4% wt/wt and about 0.6% wt/wt. In some cases, the flavoring agent is present in an amount between about 3% wt/wt and about 4% wt/wt. In some cases, the flavoring agent is present in an amount between about 0.2% wt/wt and about 0.7% wt/wt. In some cases, the flavoring agent is present in an amount of about 20% wt/wt. In some cases, the sea salt is present in an amount between about 0.4% wt/wt and about 0.6% wt/wt. In some cases, the raspberry granules are present in an amount between about 3% wt/wt and about 4% wt/wt. In some cases, the vanilla is present in an amount between about 0.2% and about 0.7%. In some cases, the whole milk powder is present in an amount of about 20% wt/wt.

### Methods of Producing Sweet Protein

### Recombinant Sweet Protein Expression

Sweet proteins of the present disclosure can be isolated from naturally occurring sources and produced recombinantly by a variety of protein expression systems, including, but not limited, to cell-based expression systems and cell-free expression systems. Sweet proteins produced recombinantly are recombinant proteins.

As used herein “recombinant protein” is a protein produced from a recombinant nucleic acid. A “recombinant nucleic acid” is a sequence that is not naturally occurring or has a sequence that is made by an artificial combination of two or more otherwise separated segments of sequence. This artificial combination is often accomplished by chemical synthesis or by the artificial manipulation of isolated segments of nucleic acids, e.g., by genetic engineering techniques. The term recombinant nucleic acids includes nucleic acids that have been altered solely by addition, substitution, or deletion of a portion of the nucleic acid. Frequently, a recombinant nucleic acid may include a nucleic acid sequence operably linked to a promoter sequence. Such a recombinant nucleic acid may be part of a vector that is used, for example, to transform a cell.

Non-limiting examples of protein expression systems useful in producing sweet polypeptides disclosed herein include prokaryotic cell-based expression systems (e.g., archaeal systems, e.g., bacterial systems) and eukaryotic cell-based expression systems (e.g., fungal cells (filamentous fungal cells), e.g., yeast cells, insect cells, and mammalian cells).

To express a sweet polypeptide disclosed herein in a cell-based expression system, a gene encoding for the polypeptide can be introduced into a host cell of the expression system by, for example, an expression vector. A polynucleotide gene encoding for the sweet protein can be made by various methods, including molecular cloning and synthesis. Molecular cloning methods may involve mutagenesis (e.g., site-directed mutagenesis), restriction enzyme-mediated cloning (e.g., restriction enzyme digestion and ligation), polymerase chain reaction (PCR), and overlap extension. Synthesis can include chemical synthesis (e.g., gene synthesis). The gene sequence can be codon optimized for any desired expression system.

In some cases, the present disclosure provides a vector comprising a nucleic acid sequence encoding a sweet polypeptide disclosed herein. In some cases, the present disclosure provides a vector comprising a nucleic acid sequence encoding for the sweet polypeptide brazzein (e.g., a nucleic acid encoding a recombinant brazzein-53).

The coding sequence can be inserted into a vector by a variety of procedures, including, but not limited to restriction enzyme digestion, ligation, and homologous recombination. The vector may be capable of replicating and expressing the polynucleotides in prokaryotic and/or eukaryotic host cells of expression systems. A vector may contain various components that may be adjusted and optimized for compatibility with the particular host cell. A cloning vector and/or expression vector may include additional nucleic acid sequences, including but not limited to, a signal sequence, an origin of replication, a marker gene (e.g., a selection marker such as an antibiotic resistance gene), an enhancer element, a promoter, a ribosome binding site, a signal sequence, and a transcription termination sequence.

In some cases, an expression vector containing a polynucleotide encoding a sweet protein disclosed herein may further comprise a promoter. Promoters include, but are not limited to, constitutive promoters, inducible promoters, and hybrid promoters. Promoters can include, but are not limited to, acu-5, adhl+, alcohol dehydrogenase (ADH1, ADH2, ADH4), AHSB4m, AINV, alcA, a-amylase, alternative oxidase (AOD), alcohol oxidase I (AOX1), alcohol oxidase 2 (AOX2), AXDH, B2, CaMV, cellobiohydrolase I (cbhl), ccg-1, cDNAI, cellular filament polypeptide (cfp), cpc-2, ctr4+, CUP1, dihydroxyacetone synthase (DAS), enolase (ENO, ENOI), formaldehyde dehydrogenase (FLD1), FMD, formate dehydrogenase (FMDH), G1, G6, GAA, GAL1, GAL2, GAL3, GAL4, GAL5, GAL6, GAL7, GAL8, GAL9, GAL10, GCW14, gdhA, gla-1, a-glucoamylase (glaA), glyceraldehyde-3-phosphate dehydrogenase (gpdA, GAP, GAPDH), phosphoglycerate mutase (GPM1), glycerol kinase (GUT1), HSP82, invl+, isocitrate lyase (ICL1), acetohydroxy acid isomeroreductase (ILV5), KAR2, KEX2, b-galactosidase (lac4), LEET2, melO, MET3, methanol oxidase (MOX), nmt1, NSP, pcbC, PET9, peroxin 8 (PEX8), phosphoglycerate kinase (PGK, PGK1), pho1, PH05, PH089, phosphatidylinositol synthase (PIS1), PYK1, pyruvate kinase (pki1), RPS7, sorbitol dehydrogenase (SDH), 3-phospho serine aminotransferase (SER1), SSA4, SV40, TEF, translation elongation factor 1 alpha (TEF1), THI11, homoserine kinase (THR1), tpi, TPS1, triose phosphate isomerase (TPI1), XRP2, and YPT1.

In some instances, an expression vector containing a gene encoding a sweet polypeptide disclosed herein may comprise a polynucleotide sequence encoding a signal peptide. A signal peptide, also known as a signal sequence, targeting signal, localization signal, localization sequence, secretion signal, transit peptide, leader sequence, or leader peptide, may support secretion of a protein or polynucleotide. Extracellular secretion of a recombinantly expressed protein from a host cell may facilitate protein purification. For example, recovery of a recombinant protein from a cell culture supernatant may be preferable to lysing host cells to release a complex mixture of proteins, including intracellular proteins of the host cell. Secretion, in some cases, may reduce deleterious effects that intracellular overexpression of a heterologous protein may have on a host cell such as toxicity or decreased growth rate. Secretion, in some cases, may allow increased protein production compared to intracellular expression in a host cell of limited volume to store the synthesized proteins. Secretory production of a protein, in some cases, may facilitate post-translational modification or processing (e.g., protein folding, formation of disulfide bonds, and glycosylation).

As different host cells may have characteristics and specific mechanisms for the posttranslational processing and modification of protein products, appropriate cell lines or host systems may be chosen to ensure the desired modification and processing of the expressed protein. In some cases, a host cell may be selected from the group consisting of bacteria, fungi, plant cells, insect cells, mammalian cells, and any combination thereof. A host cell can be grown, fermented, or cultured in any appropriate medium that allows for host cell growth and sweet protein (e.g., recombinant brazzein-53) expression.

In some cases, a host cell selected for expression a sweet polypeptide disclosed herein is an archaeal cell. Non-limiting examples of archaeal host cells include Pyrococcus furiosus, Metallosphera sedula, Thermococcus litoralis, Methanobacterium thermoautotrophicum, Methanococcus jannaschii, Pyrococcus abyssi, Sulfolobus solfataricus, Pyrococcus woesei, Sulfolobus shibatae, and variants thereof. In some cases, a host cell selected for expression a sweet polypeptide disclosed herein is a bacterial cell. Suitable bacterial host cells include, but are not limited to, BL21 E. coli, DE3 strain E. coli, E. coli M15, DH5u, DH103, HB101, B. subtilis cells, Pseudomonas fluorescens cells, and cyanobacterial cells such as Synechococcus elongates cells.

In some cases, a host cell selected for expression of a sweet polypeptide disclosed herein may be a fungal cell. The fungal cell may be a yeast cell or a filamentous fungi. Yeast may include, but is not limited to, Arxula spp., Arxula adeninivorans, Kluyveromyces spp., Kluyveromyces lactis, Pichia spp., Pichia angusta, Pichia pastoris (also known as Komagataella phaffii), Saccharomyces spp., Saccharomyces cerevisiae, Schizosaccharomyces spp., Schizosaccharomyces pombe, Tetrahymena sp., Hansenula sp., Blastobotrys sp., Candida sp., Zygosaccharomyces sp., Debaryomyces sp. Yarrowia spp., and Yarrowia lipolytica. Fungi may include, but are not limited to, Agaricus spp., Agaricus bisporus, Aspergillus spp., Aspergillus awamori, Aspergillus fumigatus, Aspergillus nidulans, Aspergillus niger, Aspergillus oryzae, Colletotrichum spp., Colletotrichum gloeosporiodes, Endothia spp., Endothia parasitica, Fusarium spp., Fusarium graminearum, Fusarium solani, Mucor spp., Mucor miehei, Mucor pusillus, Myceliophthora spp., Myceliophthora thermophila, Neurospora spp., Neurospora crassa, Penicillium spp., Penicillium camemberti, Penicillium canescens, Penicillium chrysogenum, Penicillium (Talaromyces) emersonii, Penicillium funiculosum, Penicillium purpurogenum, Penicillium roqueforti, Pleurotus spp., Pleurotus ostreatus, Rhizomucor spp., Rhizomucor miehei, Rhizomucor pusillus, Rhizopus spp., Rhizopus arrhizus, Rhizopus oligosporus, Rhizopus oryzae, Trichoderma spp., Trichoderma altroviride, Trichoderma reesei, and Trichoderma vireus. In some cases, the host cell for expression of recombinant brazzein is a Pichia spp., such as Pichia pastoris.

In some cases, a host cell selected for expression of a sweet polypeptide disclosed herein may be an insect cell. Suitable insect host cells include, but are not limited to, Sf9 cells from Spodoptera frugiperda, Sf21 cells from Spodoptera frugiperda, Hi-Five cells, BTI-TN-5B1-4 Trichophusiani cells, and Schneider 2 (S2) cells and Schneider 3 (S3) cells from Drosophila melanogaster.

In some cases, a host cell selected for expression of a sweet polypeptide disclosed herein may be a mammalian cell. Non-limiting examples of mammalian host cells include HEK293 cells, HeLa cells, CHO cells, COS cells, Jurkat cells, NSO hybridoma cells, baby hamster kidney (BHK) cells, MDCK cells, NIH-3T3 fibroblast cells, and any other immortalized cell line derived from a mammalian cell.

In some cases, sweet polypeptides can be produced in in vitro translation systems. An in vitro translation system generally refers to a translation system which is a cell-free extract containing elements for translation of an RNA molecule into a protein. An in vitro translation system can comprise ribosomes, tRNAs, initiator methionyl-tRNAMet, proteins or complexes involved in translation, e.g., elF2, eIF3, the cap-binding (CB) complex, comprising the cap-binding protein (CBP) and eukaryotic initiation factor 4F (eIF4F). A variety of in vitro translation systems are available. Non-limiting examples of in vitro translation systems include eukaryotic lysates, such as rabbit reticulocyte lysates, rabbit oocyte lysates, human cell lysates, insect cell lysates, and wheat germ extracts.

### Synthesis of Polypeptides

Any of the peptides described herein (e.g., a sweet polypeptide, a brazzein, or a polypeptide having the amino acid sequence of SEQ ID NO: 1 or SEQ ID NO: 2) can be chemically synthesized. Method of peptide chemical synthesis are known in the art. See, for example, Isidro-Llobet et. al. 2019. Journal of Organic Chemistry. 84, 8, 4615-4628 or Stawikowski and Fields. 2002. Curr. Protoc. Protein Sci. doi: 10.1002/0471140864.ps1801s26.

### Recovery and Purification of Sweet Polypeptides

Expressed sweet polypeptides described herein can be recovered, isolated, and/or purified from the supernatant of a cell culture, for example, if the expressed protein is secreted by the host cell into the cell culture medium. Expressed sweet polypeptides described herein can, in some cases, be recovered from the host cell, for example, if the protein is expressed intracellularly. Proteins can be recovered from the intracellular space by disrupting the host cell, for example, by osmotic shock, sonication, or lysis. Once the cells are disrupted, cell debris may be removed by centrifugation or filtration, and the expressed proteins can be removed or recovered from the cell lysate.

In some cases, the polypeptide may be produced using in vitro or cell-free protein synthesis systems, for example, using a cell-free translation system comprising a cell extract such as Escherichia coli cell extract, rabbit reticulocyte cell extract, wheat germ cell extract, or insect cell extract. The expressed protein may be recovered, isolated, and/or optionally purified from the cell extract by any suitable method.

Polypeptides can be recovered and/or isolated from supernatants and lysates by any of a variety of methods, including, but not limited to, chemical extraction, column chromatography, and filtration. The polypeptides may be purified using any of a variety of methods including liquid chromatography such as normal or reversed phase, high-performance liquid chromatography (HPLC), fast protein liquid chromatography (FPLC), and the like; affinity chromatography such as with inorganic ligands, monoclonal antibodies (e.g., immunoaffinity), and ion exchange (e.g., anion exchange, cation exchange); hydrophobic interaction chromatography; size exclusion chromatography; immobilized metal chelate chromatography; gel electrophoresis; ethanol precipitation; and any combination thereof. In some cases, the polypeptides can be purified by centrifugation and/or filtration, including sterile filtration, depth filtration, tangential flow filtration, ultrafiltration (UF), diafiltration (DF), and ultrafiltration/diafiltration (UF/DF).

The polypeptides can be concentrated, dehydrated, dewatered, or dried by freeze drying, vacuum tray drying, spray drying, rotary drum drying, or any combination thereof. Drying can be done in a desiccator, vacuum dryer, conical dryer, spray dryer, fluid bed or any method known in the art. Preferably, methods are chosen that yield a dried product (e.g., a powder) with the greatest sweetness. The dried sweet protein can be optionally blended, pestled, milled, conched, pulverized, or other methods of processing known in the art. The resulting concentrated liquid or solid powder can be stored, diluted, rehydrated, or used in the formulation of food and beverage products, such as the chocolate compositions herein. In some cases, the concentrated liquid or solid powder can be stored at −20° C., 4° C., or room temperature without significant loss in sweetness. In some cases, the concentrated liquid can be diluted using water or the fat. In some cases, the solid powder can be rehydrated at a paste or a liquid using water or another liquid in which the solid powder is soluble.

Where the term “substantially purified” is used, this will refer to a composition in which the specific protein, peptide, or peptide forms the major component of the composition, such as constituting about 50% of the peptides in the composition or more. In preferred cases, a substantially purified peptide will constitute more than 60%, 70%, 80%, 90%, 95%, 99% or even more of the peptides in the composition.

A peptide, polypeptide or protein that is “purified to homogeneity,” as applied to the present disclosure, means that the peptide, polypeptide or protein has a level of purity where the peptide, polypeptide or protein is substantially purified or free from other proteins/peptides and biological components. For example, a purified peptide, polypeptide or protein will often be sufficiently free of other protein/peptide components so that degradative sequencing can be performed successfully.

Although preferred for use in some cases, there is no general requirement that the protein, polypeptide, or peptide always be provided in their most purified state. Indeed, it is contemplated that less substantially purified protein, polypeptide or peptide, which are nonetheless enriched in the desired peptide compositions, relative to the natural state, will have utility in some cases. As used herein “enriched” refers to a component, such as a peptide or protein, that is found at a high concentration in a solution or composition than in nature when produced the same way. Methods of enrichment of a component, such as enrichment of a peptide, are known in the art and are often similar to those of purification of components or peptides.

In other cases, a preparation enriched with the peptides can be used instead of a purified preparation. In this document, whenever purified is used, enriched can be used also. A preparation can be enriched not only by methods of purification, but also by the over-expression or over-production of the peptide by bacteria when compared to wild-type. This can be accomplished using recombinant methods, or by selecting conditions which will induce the expression of the peptide from the wild type cells.

### Compositions and Products Comprising the Chocolate Compositions

Non-exemplary chocolate compositions can include a solid chocolate, a liquid chocolate, or a powdered chocolate. Exemplary solid chocolates include bars, drops, balls, chips, shavings as well as further formulation of the chocolate into other candies (e.g., such as combined with a hard shell, combined with peanut butter, layered or spread onto cookies or other baked goods). Exemplary liquid chocolates include syrups, liquors and formulations with other liquids (e.g., water).

### Definitions

The term “promoter” is a nucleic acid sequence that is operably linked to a nucleic acid sequence encoding a polypeptide (e.g., a recombinant peptide) that can increase the transcription of the nucleic acid sequence encoding the polypeptide (e.g., a peptide described herein). In some cases, a promoter is constitutive. In other cases, a promoter is inducible. Non-limiting examples of promoters are described herein. Additional examples of promoters are known in the art.

The term “culturing” refers to growing a population of cells, e.g., microbial cells, under suitable conditions for growth, in a liquid or solid medium.

The term “purifying” means a step performed to isolate a recombinant peptide from one or more other impurities (e.g., bulk impurities) or components present in a fluid containing a recombinant peptide (e.g., liquid culture medium polypeptides or one or more other components (e.g., DNA, RNA, other polypeptides, endotoxins, viruses, etc.) present in or secreted from a mammalian cell).

The terms “isolated”, “purified”, “separated”, and “recovered” as used herein refer to a material (e.g., a polypeptide, nucleic acid, or cell) that is removed from at least one component with which it is naturally associated, for example, at a concentration of at least 90% by weight, or at least 95% by weight, or at least 98% by weight of the sample in which it is contained. For example, these terms can refer to a material which is substantially or essentially free from components which normally accompany it as found in its native state, such as, for example, an intact biological system, or is substantially or essentially free from other proteins in the system from which it is expressed.

As used herein, the term “host cell” refers to a cell or cell line into which a recombinant expression vector (e.g., a nucleic acid construct) can be introduced for expression of the peptide in the host cell. A host cell comprising a recombinant vector can be referred to as a “recombinant host cell.”

The term “ppm”, as used herein, means parts-per-million and is a weight relative parameter. A part-per-million is a microgram per gram, such that a component that is present at 10 ppm is present at 10 micrograms of the specific component per 1 gram of the aggregate mixture.

Reference to the term “about” has its usual meaning in the context of compositions to allow for reasonable variations in amounts that can achieve the same effect and also refers herein to a value of plus or minus 10% of the provided value. For example, “about 20” means or includes amounts from 18 to and including 22.

Unless otherwise required by context, singular terms shall include pluralities and plural terms shall include the singular. As used herein, the singular form “a”, “an”, and “the” include plural references unless indicated otherwise. For example, “an” excipient includes one or more excipients.

It is understood that aspects and variations of the invention described herein include “comprising”, “consisting of” and/or “consisting essentially of” aspects and variations thereof.

### EXAMPLES

Various aspects of the disclosure are further illustrated by the following non-limiting examples.

### Example 1. Producing Recombinant Brazzein in Pichia pastoris

To express recombinant brazzein-53 (SEQ ID NO: 2) in Pichia pastoris, a high-copy P. pastoris colony was first generated. The brazzein gene was codon optimized for P. pastoris. The gene was then synthesized and cloned into a modified pPIC9K vector (Thermo Fisher Scientific V17520) with GAP promoter. The synthesized plasmid (2 picograms) was linearized with SalI restriction enzyme (New England Biolabs) and gel purified. The linearized plasmid was transformed into P. pastoris GS115 competent cells (Thermo Fisher Scientific C18100) according to the manufacturer's instruction manual (Thermo Fisher Scientific K171001). High copy colonies were screened by YPD plates with 4 micrograms/milliliter geneticin.

The selected high copy colony was then grown in 4 ml MGY (˜ pH 4) media at 28° C. with shaking (250 revolutions per minute (rpm)). One milliliter of the culture was harvested every 24 hours for dot blot analysis to confirm protein expression and secretion. Samples were harvested by centrifugation at 14,000 rpm for 2 minutes. The supernatant was collected and loaded onto nitrocellulose membrane for dot blot. Brazzein expression in P. pastoris culture supernatant was confirmed at the cloning stage.

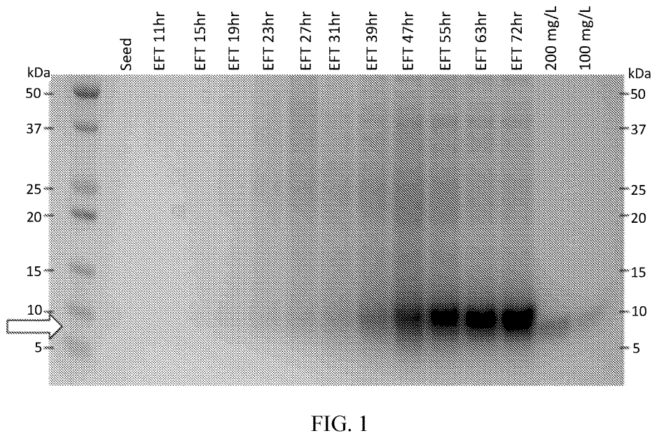

To manufacture recombinant brazzein-53, the P. pastoris strain that produces brazzein-53 was amplified through multiple seed propagation steps in sequentially larger bioreactors using a media with yeast nitrogen base, anhydrous ammonium sulfate, anhydrous monobasic potassium phosphate, anhydrous dibasic potassium phosphate, glucose and biotin at about pH 6. Culture from the seed propagation steps was used to inoculate a fermenter in media containing yeast nitrogen base, anhydrous ammonium sulfate, glucose and biotin at pH 6. A 72-hour feed-batch fermentation was completed and harvested. Protein production was monitored by assaying samples by SDS-PAGE for the presence of the 6.5 kDa protein as compared to known standards (FIG. 1). Following harvest at the final time point, a primary cell separation (PCS) was performed. Additional purification steps were performed including centrifugation, filtration, cation exchange chromatography, and nanofiltration/diafiltration. The product containing the recombinant brazzein was dried to produce a white powder, which was subsequently used in the following examples (listed as “Brazzein-53”).

### Example 2. Exemplary 55% Dark Chocolate Formulation

An exemplary 55% dark chocolate formulation is provided in Table 2.

TABLE 2
Exemplary 55% Dark Chocolate Formulation.

| | Percent of Ingredients in |
|---|---|
| | 55% Dark Chocolate |
| Ingredient | Formulation 1 |
| Cocoa Liquor | 35% |
| Powdered Cocoa Butter | 20% |
| Light Agave Syrup | 8% |
| Liquid Soy Lecithin | 6% |
| Brazzein-53 | 0.0155% |
| Chicory Root Fiber | 14% |
| Milk Powder | 15% |
| Chocolate Enhancer | 1% |
| Mycyro Powder | 1% |

Chocolate Making Procedure: The cocoa liquor and liquid soy lecithin were melted using the double boiler with a maximum temperature of approximately 43-44° C. The dry ingredients, including brazzein-53, but excluding the cocoa butter and mycryo powder, were added and mixed until components were dissolved and incorporated. The mixture was cooled to approximately 31-32° C. and no additional water was added. This helped prevent chocolate blooms and ensured proper setting. Once the chocolate reached approximately 31-32° C., the powdered cocoa butter was added to the mixture and incorporated to help ensure proper tempering. The mixture was then poured into molds and remained at room temperature until hardened, approximately 10-15 minutes. Once hardened, the chocolate was placed at approximately 4° C. for 1-2 hours without a cover, until completely hardened. Chocolate was stored at room temperature, preferably from 18-24° C. Direct sunlight and/or heat was avoided.

### Example 3. Brazzein-53 Titration for Chocolate Formulations

Initial formulations contained 1500 ppm of brazzein-53, soluble corn fiber, and 5 g cane sugar per serving. Then the amount of brazzein-53 was reduced to 1000 ppm, soluble corn fiber was replaced with chicory root fiber, and the amount of sugar was reduced to 4 g of cane sugar. Formulations were then further reduced to 500 ppm brazzein-53, and vanilla powder was replaced with ground vanilla beans, cane sugar was replaced with coconut sugar, and coconut sugar was reduced to 3 g total.

Exemplary dark chocolate formulations can be found in Table 3. Chocolate was formulated by first mixing all of the dry ingredients (as indicated in Table 3 below) together. The chocolate liquor (Barry Caliebaut) was combined with deodorized cocoa butter (Barry Caliebaut) and melted to a temperature of about 140° F. The melted mixture was combined with the dry ingredients to form a soft paste. The paste was refined to a particle size target of 25 microns in diameter, and then conched for approximately 6 hours at a temperature of about 130° F. Up to 50% of the lecithin (Solae) and cocoa butter were added to facilitate flow. The remaining lecithin and cocoa butter were then added, and the combined ingredients were mixed for 15 minutes. The chocolate mix was then tempered to complete the formulation.

TABLE 3
Exemplary Dark Chocolate Formulations.

| | Percentage of Ingredient in Formulation | | | |
|---|---|---|---|---|
| | Formulation | Formulation | Formulation | Formulation |
| Ingredient | 2 | 3 | 4 | 5 |
| Chocolate | 70 | 70 | 70 | 70 |
| Liquor | | | | |
| Chicory Root | 15.25 | 18.1 | 15.5 | 11 |
| Inulin | | | | |
| Cane Sugar, | 0 | 0 | 11.5 | 15 |
| Pulverized | | | | |
| Coconut Sugar, | 12 | 9.3 | 0 | 0 |
| Fine Milled | | | | |
| (84.2% Sugar) | | | | |
| Cocoa Butter, | 1.7 | 1.7 | 2.1 | 1 |
| Deodorized | | | | |
| Madagascar | 0.8 | 0.6 | 0 | 0 |
| Bourbon | | | | |
| Ground | | | | |
| Vanilla Beans | | | | |
| Madagascar | 0 | 0 | 0.5 | 0.35 |
| Bourbon | | | | |
| Vanilla | | | | |
| Extract Powder | | | | |
| Lecithin, | 0.25 | 0.25 | 0.3 | 0.3 |
| Sunflower | | | | |
| Brazzein-53 | 0 | 0.05 | 0.1 | 0.16 |

A comparison of the formulations indicated a range of coconut sugar was necessary to achieve an optimal sweetness with brazzein-53. Sweetness became difficult to detect when coconut sugar was below 3 g per 30 g serving of the chocolate. A preferred range of brazzein-53 was set at 200-500 ppm, when used in combination with 3 g of coconut sugar (e.g., formulation 3 in Table 2). Chocolate formulations were tasted by approximated 6-8 subjects. As brazzein-53 concentration increased to 500 ppm, a slight lingering tail of sweetness was detected by some subjects.

### Example 4. Exemplary Dark Chocolate Formulations with Hand Mixing

Amounts of brazzein-53 were tested for sweetness levels. No sweetness detected at 100 ppm brazzein-53 when mixed with an unsweetened chocolate by hand. The bitterness of the unsweetened chocolate was overpowering. In comparison, the sweetness of chocolate that included 300 ppm brazzein-53 was detectable at this level but lacked the intensity desired for a chocolate product. Additionally, the sweetness became detectable very late after tasting the chocolate formulation.

A balance of chocolate and sweetener was then tested. Unsweetened chocolate was melted, and coconut sugar was incorporated via hand mixing at an amount equivalent to 3 grams of added sugar per 30 gram serving. The melted sweetened chocolate was then portioned out for screening of brazzein-53 at 400 ppm. It was observed that the overall sweetness is improved with the addition of the added coconut sugar. However, the texture of the chocolate was grainy, likely as a result of sugar addition and hand mixing. A slight linger in the sweetness tail was detected by several tasters.

### Example 5. Exemplary Dark Chocolate Formulations with Conch Mixing

Chocolate Protocol: Granulated Coconut Sugar was pulverized to a fine powder with particles of about 80-100 microns in diameter. All dry ingredients, including brazzein-53, were blended together. The chocolate liquor and cocoa butter were melted at about 140° F. The chocolate liquor was mixed with the dry ingredients to form a soft paste, which was refined to a target particle size of about 25 microns in diameter. The paste was mixed in the conch for minimum 7 hours at about 130-140° F. Up to 50% of the cocoa butter was added as necessary to facilitate paste flow. The remaining cocoa butter was added, and the resulting mixture was mixed in the conch for about 15 minutes. The dark chocolate mixture was tempered, allowed to set in molds, unmolded, and then packaged.

Additional flavoring agents were then added, if included, and the mixture was blended until the additional flavoring agents were well dispersed. For example, sea salt or raspberry granules (e.g., freeze dried raspberry pieces) were added were separately added to the chocolate mixture. Exemplary dark chocolate formulations are provided in Table 4.

TABLE 4
Additional Exemplary Dark Chocolate Formulations.

| | Percentage of Ingredient in Formulation | | |
|---|---|---|---|
| | | Formulation 7 | Formulation 8 |
| | Formulation 6 | (Sea Salt | (Raspberry |
| | (Dark | Dark | Dark |
| Ingredient | Chocolate) | Chocolate) | Chocolate) |
| Chocolate | 70.0 | 70.0 | 70.0 |
| Liquor | | | |
| Chicory Root | 15.8 | 15.84 | 15.84 |
| Inulin | | | |
| Coconut Sugar, | 10.0 | 10.0 | 10.0 |
| Fine Milled | | | |
| (84.2% Sugar) | | | |
| Cocoa Butter, | 3.45 | 3.45 | 3.45 |
| Deodorized | | | |
| Madagascar | 0.66 | 0.55 | 0.66 |
| Bourbon Ground | | | |
| Vanilla Beans | | | |
| Brazzein-53 | 0.05 | 0.05 | 0.05 |
| Sea Salt | 0 | 0.5025 | 0 |
| Raspberry | 0 | 0 | 3.6 |
| Granules | | | |

### Example 6. Exemplary Milk Chocolate Formulations

A milk chocolate is prepared in a similar manner to Example 5. Brazzein-53 in a range between 100-800 ppm is used as a sweetener along with coconut sugar. Optionally, cocoa levels are reduced as compared to the dark chocolate, such as described in examples 4 and 5. For instance, 275 ppm brazzein-53 with added milk or milk solids is used to create a milk chocolate. Additionally, a second milk chocolate formulation includes 350 ppm brazzein-53, 60% cocoa, milk or milk solids.

### Example 7. Exemplary Dark Chocolate Formulations

An exemplary dark chocolate formulation is provided in Table 5.

TABLE 5
Exemplary Dark Chocolate Formulation.

| | Percent |
|---|---|
| Ingredient | (wt/total wt) |
| Chocolate liquor | 70.0 |
| Chicory root inulin | 12.8 |
| Coconut sugar | 10.5 |
| (84.2% Sugar) | |
| Cocoa butter | 6.0 |
| Vanilla bean | 0.66 |

| Ingredient | ppm |
|---|---|
| Brazzein-53 protein | 195 |
| Brazzein-54 protein | 27.9 |

Chocolate Making Procedure: All dry ingredients were first blended together. The chocolate liquor and cocoa butter were melted to a temperature of about 140° F. and then mixed with the dry ingredients to form a soft paste. The mixture was refined to a target of 25 microns. The mixture was conched for minimum 7 hours at about 130-140° F. Additional cocoa butter was added as necessary to facilitate flow. Any remaining cocoa butter added at the end of the conching was allowed to conch for an additional 15 minutes. The chocolate was then tempered to create the final product.

Additionally, an exemplary dark chocolate was constructed following the methods above using only brazzein-53 protein (no brazzein-54) at 215 ppm of brazzein-53 protein.

### Example 8. Exemplary Milk Chocolate Formulation

An exemplary milk chocolate formulation is provided in Table 6.

TABLE 6
Exemplary Milk Chocolate Formulation.

| | Percent |
|---|---|
| Ingredient | (wt/total wt) |
| Chocolate liquor | 20.38 |
| Chicory root inulin | 17.4 |
| Coconut sugar | 9.5 |
| (84.2% Sugar) | |
| Tapioca fiber | 9.25 |
| Whole milk powder | 20.0 |
| Cocoa butter | 22.99 |
| Vanilla bean | 0.36 |
| Natural vanilla | 0.08 |
| flavoring | |

| Ingredient | ppm |
|---|---|
| Brazzein-53 protein | 234 |
| Brazzein-54 protein | 33.5 |

Chocolate Making Procedure: All dry ingredients were first blended together with the chocolate liquor. The cocoa butter was melted to a temperature of about 140° F. and then a portion (˜20%) was mixed with the other ingredients to form a soft paste. The mixture was refined to a target of 25 microns. The mixture was conched for minimum 4 hours at about 130° F. Additional cocoa butter was added as necessary to facilitate flow. Any remaining cocoa butter was added at the end of the conching and was allowed to conch for an additional 15 minutes. The chocolate was then tempered to create the final product.

Based on the dark chocolate and milk chocolate formulations, ranges for brazzein-53 protein and brazzein-54 protein are set forth below in Table 7.

TABLE 7
Exemplary ppm ranges of brazzein proteins
for milk and dark chocolates

| | Brazzein-53 | Brazzein-54 | |
|---|---|---|---|
| Chocolate Composition | protein | protein | |
| Single BRZ-53 Dark | 150-280 ppm | — | |
| Single BRZ-54 Dark | — | 600-1,120 | ppm |
| BRZ-53 + BRZ-54 Dark | 135-255 ppm | 20-40 | ppm |
| Single BRZ-53 Milk | 180-335 ppm | — | |
| Single BRZ-54 Milk | — | 720-1,340 | ppm |
| BRZ-53 + BRZ-54 Milk | 165-305 ppm | 25-50 | ppm |

### Example 9 Exemplary Reduced Sugar Chocolates

Following the methods similar to described in Examples 7, exemplary chocolates were made with a further reduced amount of low glycemic sweetener. An exemplary dark chocolate formulation is provided in Table 8.

TABLE 8
Exemplary Dark Chocolate Formulation.

| | Percent |
|---|---|
| Ingredient | (wt/total wt) |
| Chocolate liquor | 73.4 |
| Chicory root inulin | 15.2 |
| Coconut sugar | 2.1 |
| (84.2% Sugar) | |
| Cocoa butter | 8.5 |
| Vanilla bean | 0.72 |

| Ingredient | ppm |
|---|---|
| Brazzein-53 protein | 160 |
| Brazzein-54 protein | 35 |

What is claimed is:

1. A chocolate composition comprising:
a recombinant brazzein-54;
a recombinant brazzein-53; and
a bulking agent.

2. The chocolate composition of claim 1, wherein the recombinant brazzein-54 is present in the composition between 20 ppm and 40 ppm.

3. The chocolate composition of claim 1, wherein the recombinant brazzein-53 is present in the composition between 100 ppm and 500 ppm, optionally between 135 ppm and 335 ppm, and the recombinant brazzein-54 is present in the composition between 10 ppm and 100 ppm, optionally between 20 ppm and 50 ppm or between 20 ppm and 40 ppm.

4. The chocolate composition of any one of claims 1-3, wherein the composition further comprises a low glycemic index sweetener.

5. The chocolate composition of claim 4, wherein the ratio of recombinant brazzein-53 to low glycemic index sweetener (wt/wt) is between about 1:190 and about 1:1125.

6. The chocolate composition of claim 4, wherein the ratio of recombinant brazzein-53 to low glycemic index sweetener (wt/wt) is between about 1:29 and about 1:778.

7. The chocolate composition of any one of claims 4-6, wherein the ratio of recombinant brazzein-54 to low glycemic index sweetener (wt/wt) is between about 1:900 and about 1:7500.

8. The chocolate composition of any one of claims 4-6, wherein the ratio of recombinant brazzein-54 to low glycemic index sweetener (wt/wt) is between about 1:7 and about 1:5250.

9. The chocolate composition of any one of claims 1-8, wherein the composition further comprises cocoa and a fat.

10. The chocolate composition of any one of claims 1-9, wherein the composition further comprises an emulsifier.

11. The chocolate composition of any one of claims 1-10, wherein the recombinant brazzein-53 is present in the composition between 135 ppm and 255 ppm, and the recombinant brazzein-54 is present in the composition between 20 ppm and 40 ppm.

12. The chocolate composition of any one of claims 1-10, wherein the recombinant brazzein-53 is present in the composition between 160 ppm and 305 ppm, and the recombinant brazzein-54 is present in the composition between 20 ppm and 50 ppm.

13. A chocolate composition comprising:
a recombinant brazzein-53;
a low glycemic index sweetener;
cocoa;
a bulking agent;
a fat; and
optionally an emulsifier,
wherein the recombinant brazzein-53 is present in the composition between 100 ppm and 1600 ppm, optionally between 135 ppm and 335 ppm.

14. The chocolate composition of claim 13, wherein the recombinant brazzein-53 is present in the composition between 150 ppm and 280 ppm.

15. The chocolate composition of claim 13 or claim 14, wherein the recombinant brazzein-53 is the only brazzein protein in the chocolate composition.

16. The chocolate composition of any one of claims 13-15, wherein the ratio of recombinant brazzein-53 to low glycemic index sweetener (wt/wt) is between about 1:130 and about 1:1000.

17. The chocolate composition of any one of claim 13, 14, or 16, further comprising brazzein-54.

18. The chocolate composition of claim 17, wherein the brazzein-54 is a recombinant brazzein-54.

19. The chocolate composition of claim 17 or claim 18, wherein the ratio of recombinant brazzein-54 to low glycemic index sweetener (wt/wt) is between about 1:7 and about 1:5250 or about 1:900 and about 1:7500.

20. A chocolate composition comprising:
a recombinant brazzein-54;
a low glycemic index sweetener;
cocoa;
a bulking agent;
a fat; and
optionally an emulsifier,
wherein the recombinant brazzein-54 is present in the composition between 10 ppm and 1600 ppm, optionally between 600 ppm and 1120 ppm or between 720 ppm and 1340 ppm.

21. The chocolate composition of claim 20, wherein brazzein-54 is the only brazzein protein in the chocolate composition.

22. The chocolate composition of claim 20, wherein the ratio of recombinant brazzein-54 to low glycemic index sweetener (wt/wt) is between about 1:33 and about 1:250.

23. The chocolate composition of claim 20, wherein the ratio of recombinant brazzein-54 to low glycemic index sweetener (wt/wt) is between about 1:33 and about 1:7500.

24. The chocolate composition of any one of claims 1-23, wherein the chocolate composition is a dark chocolate.

25. The chocolate composition of claims 1-23, wherein the chocolate composition is a milk chocolate.

26. The chocolate composition of any one of claims 4-25, wherein the low glycemic index sweetener is a natural sweetener.

27. The chocolate composition of claim 26, wherein the natural sweetener is agave, or coconut sugar.

28. The chocolate composition of any one of claims 4-27, wherein the low glycemic index sweetener is present in an amount between 5-15% wt/wt.

29. The chocolate composition of any one of claims 1-28, wherein the bulking agent comprises a low glycemic index bulking agent.

30. The chocolate composition of claim 29, wherein the low glycemic index bulking agent is tapioca fiber, chicory root fiber, inulin, or soluble corn fiber.

31. The chocolate composition of claim 30, wherein the inulin is isolated inulin, chicory root inulin, or isolated chicory root inulin.

32. The chocolate composition of any one of claims 29-31, wherein the low glycemic index bulking agent is present in an amount between 10-30% wt/wt.

33. The chocolate composition of any one of claims 1-32, wherein the composition does not contain a sugar alcohol.

34. The chocolate composition of any one of claims 9-33, wherein the fat is present in an amount between 3-25% wt/wt.

35. The chocolate composition of claim 34, wherein the fat is cocoa butter.

36. The chocolate composition of any one of claims 1-35, further comprising an emulsifier in an amount between 0.1%-20%% wt/wt.

37. The chocolate composition of claim 36, wherein the emulsifier is lecithin.

38. The chocolate composition of any one of claims 9-37, wherein cocoa is selected from a cocoa powder, a chocolate liquor or a cocoa mass.

39. The chocolate composition of any one of claims 9-38, wherein the cocoa is present in an amount between 15% and 80% wt/wt.

40. The chocolate composition of any one of claims 1-39, wherein the composition does not comprise cane sugar.

41. The chocolate composition of any one of claims 1-40, wherein the ingredients providing sweetness comprises only nature identical ingredients.

42. The chocolate composition of any one of claims 1-41, further comprising an additional flavoring agent.

43. The chocolate composition of claim 42, wherein the additional flavoring agent is selected from sea salt, raspberry granules, and vanilla.

44. A solid chocolate comprising the chocolate composition of any one of claims 1-43.

45. A liquid chocolate comprising the chocolate composition of any one of claims 1-43.
